(19) United States
(12) Patent Application Publication
(10) Pub. No.: US 2014/0006173 A1
(43) Pub. Date: Jan. 2, 2014

(54) INTERFACE FOR SPONSORING STORIES WITHIN A SOCIAL NETWORKING SYSTEM

(71) Applicants: Ning Li, Newark, CA (US); Philip Anastasios Zigoris, San Francisco, CA (US); Neville Bowers, Palo Alto, CA (US); Robert Kang-Xing Jin, Palo Alto, CA (US)

(72) Inventors: Ning Li, Newark, CA (US); Philip Anastasios Zigoris, San Francisco, CA (US); Neville Bowers, Palo Alto, CA (US); Robert Kang-Xing Jin, Palo Alto, CA (US)

(21) Appl. No.: 13/539,410

(22) Filed: Jun. 30, 2012

(51) Int. Cl. G06Q 30/02

(52) U.S. Cl. 705/14.71

(57) ABSTRACT

A social networking system displays a story about an object to a user accessing a page associated with the object and determines whether the user is authorized to promote the object. If the user is authorized to promote the object, a promote option is displayed next to a story about the object included in the page, which may comprise a newsfeed of stories on the page. After accessing the promote option for a particular story, the user is prompted to provide data specifying how the story associated with the accessed promote option is to be distributed to other users. For example, a promotion interface is displayed to the user for providing data such as targeting criteria, bid amounts, and budget. The result generates a request for a sponsored story, which may then be displayed to other users of the social networking system in accordance with the request.

### BACKGROUND

This invention generally pertains to social networking, and more specifically to advertising via a social networking system.

Social networks, or social utilities that track and enable connections between users (including people, businesses, and other entities), have become prevalent in recent years and allow users to communicate information more efficiently. For example, a social networking system user may post contact information, background information, job information, hobbies, and/or other user-specific data to the social networking system. Other users can then review the posted data by browsing user profiles or searching for profiles including specific data. Social networking systems also allow users to associate themselves with other users, thus creating a web of connections among the users of the social networking system. These connections among the users can be leveraged by the social networking system to offer more relevant information to each user in view of user-stated interests.

Additionally, social networking systems enable users to interact with other users or objects by performing various actions. For example, users may post comments to pages associated with other users, view images, view video, listen to audio data or perform other actions on various objects maintained by the social networking system. Actions performed by a user are frequently distributed to other users connected to the user who performed the action. Often, social networking systems generate newsfeeds for their users, where various stories in the newsfeed describe actions performed by other users connected to the user viewing the newsfeed. A social networking system may prioritize stories in the newsfeed so that stories likely to be of interest to the viewing user are more readily accessible to the viewing user. For example, stories describing actions performed by users with whom the viewing user frequently interacts or describing actions performed on objects in which the user has a particular interest may be easier to view via the newsfeed.

Advertisers have attempted to use social networking system newsfeeds to promote particular products or services. For example, a social networking system allows advertisers to sponsor stories in a newsfeed that inform a viewing user of particular actions taken by other users or allow the advertiser to include other material in a user's newsfeed. Hence, the advertiser compensates the social networking system to include a story selected by the advertiser in a viewing user's newsfeed or to modify the location of the selected story in the viewing user's newsfeed. Such a “sponsored story” seeks to increase user interaction with an advertiser by allowing the advertiser to provide users with personalized information about actions of other social networking system users associated with the advertiser, or with a product or service provided by the advertiser.

However, conventional techniques enabling an advertiser to select sponsored stories require the advertiser to provide a comprehensive set of information identifying when and how to present the sponsored story. Commonly, an advertiser uses an application programming interface (API) to provide a social networking system with information describing presentation of sponsored stories. In conventional scenarios, the APIs used may be complex or require more detailed information than needed for an advertiser. This complexity in configuring sponsored story presentation may deter advertisers from presenting sponsored stories to social networking system users.

### SUMMARY

Embodiments of the invention enable advertisers to promote certain actions, posts, or other content that is represented in a social networking system. The promotions may take the form of “sponsored stories,” which may comprise a story delivered to a user of the social networking system about an interaction of one of the user's friends with a particular object in the system. To simplify promotion of sponsored stories, embodiments of the invention enable advertisers to more easily generate requests for sponsored stories more using interface controls that enable promoting specific actions, posts, or other content viewable in an interface of the social networking system.

A social networking system allows a viewing user to receive descriptions of actions performed by other users connected to the viewing user or content associated with objects maintained by the social networking system. To communicate this information to the viewing user, the social networking system may generate a newsfeed for presentation to the viewing user. The newsfeed includes stories describing actions, objects or other content likely to be of interest to the viewing user. For example, the newsfeed includes stories describing actions performed by other users connected to the viewing user. Commonly, the social networking system will select stories for the newsfeed based on the likelihood that the viewing user will be interested in an action, object, user or other content identified by the stories. However, advertisers may compensate the social networking system to increase the likelihood that stories selected by the advertiser are included in the viewing user's newsfeed or that stories selected by the advertiser are readily identified from the viewing user's newsfeed.

The social networking system may include one or more pages associated with various objects, allowing users to obtain information about an object by viewing or accessing the page. For example, a page associated with an event includes images, comments by other users about the event, information about the event or other content about the event. To increase awareness of the object, content presented on a page associated with an object may be distributed to social networking system users. For example, users may receive newsfeed stories describing content of the page associated with the object or receive notifications specifying content included on the page associated with the object. To facilitate distribution of content about an object, certain users of the social networking system may be authorized to promote the object or an action associated with the object (“promoting users”) by identifying content for distribution to other users. For example, a promoting user may customize how data about the object or action is distributed to other users. Examples of users authorized to promote the object include a user creating the object, a user creating a page associated with the object, a user maintaining the page or a user updating the object. In some embodiments, promoting users may be limited to users creating content about an object or action or users maintaining or creating a page associated with the object.

To increase the likelihood that social networking system users interact with the object, a user authorized to promote the object may customize or tailor how content associated with the object is distributed. For example, an authorized user may specify a budget and/or bid amounts used to compensate the social networking system for placing stories associated with the object in newsfeeds of other users. As another example, an authorized user may specify targeting criteria for content about the object to distribute the content to a particular group of users. To simplify distribution of content associated with an object (i.e., to more easily promote the object) the social networking system presents a promote object along with content on a page associated with a content to users authorized to promote the object viewing the page.

When a user requests a page associated with an object, the social networking system determines whether the user is authorized to promote the object. A promote option is associated with content on the page and displayed proximate to content on the page. For example, if a user profile associated with the user indicates the user is authorized to promote the object, a promote button is displayed proximate to different pieces of content on the page. The authorized user may promote content on the page, such as a story, by interacting with the associated promote option.

In one embodiment, after accessing a promote button, the authorized user is prompted to specify parameters for distributing the content associated with the accessed promote button. This allows the authorized user to quickly and simply provide the social networking system with parameters or criteria for more effectively notifying other users of the object. For example, accessing a promote button presents a promotion interface to the authorized user for receiving parameters to customize promotion of the content. Examples of parameters used to promote the content include a budget, a promotion duration, bid amounts or targeting criteria. The parameters are used by the social networking system sponsored story request, which generates a sponsored story based on an action or object in the content associated with the accessed promote button using the received parameters. The social networking system distributes the content to other users based on the received parameters for promoting the content by generating a sponsored story request for the content associated with the accessed promote option based on the parameters received via the promotion interface. Hence, the promote option allows users to easily identify content to be promoted and to provide parameters for customizing promotion of identified content.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is an interaction diagram of a method for promoting a story in a social networking system, in accordance with an embodiment of the invention.

FIG. 2 is a high level block diagram illustrating a system environment suitable for operation of a social networking system, in accordance with an embodiment of the invention.

FIG. 3 is a block diagram of a social networking system, in accordance with an embodiment of the invention.

FIG. 4A is an example user interface for promoting a story on a social networking system page, in accordance with an embodiment of the invention.

FIG. 4B is an illustration of a promotion interface for receiving parameters for modifying distribution of a story to social networking system users, in accordance with an embodiment of the invention.

FIG. 5 illustrates one embodiment of a method for promoting content in a social networking system, in accordance with an embodiment of the invention.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

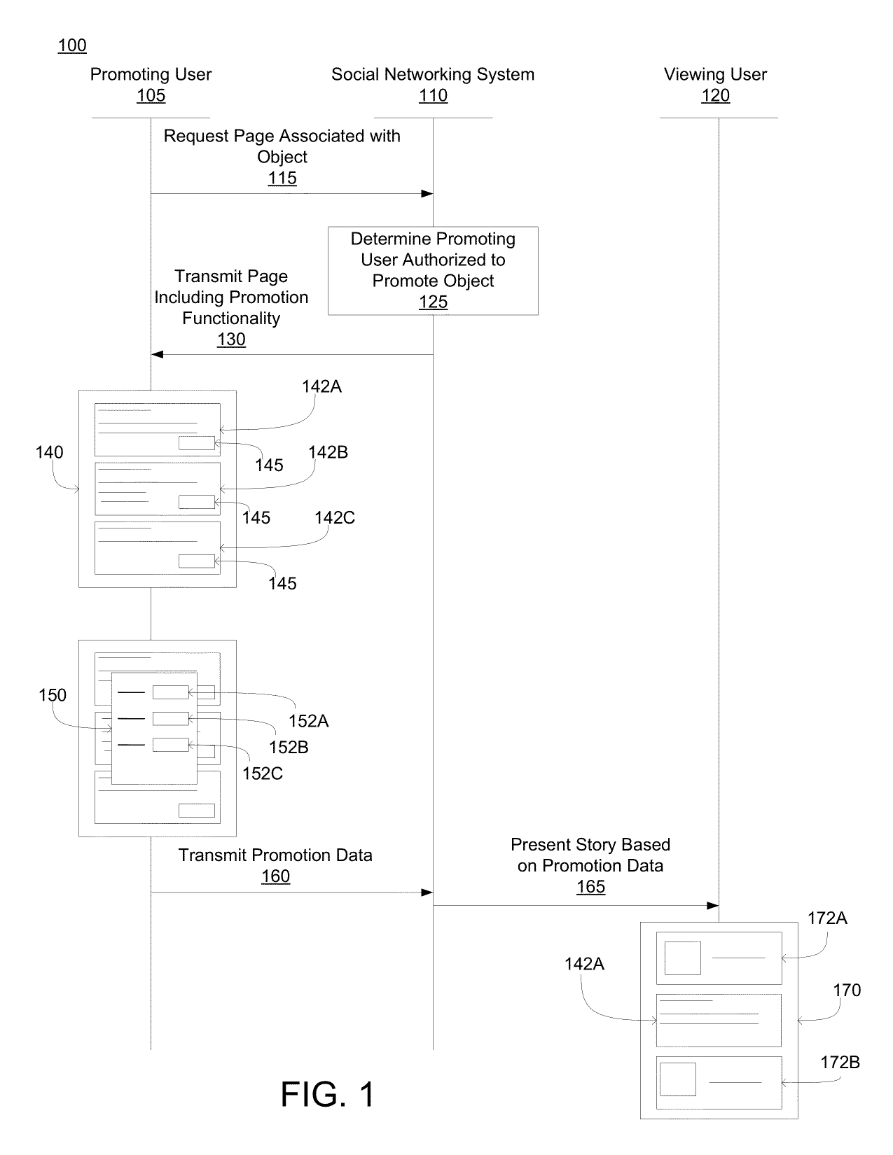

FIG. 1 is an interaction diagram 100 of a method for promoting a story in a social networking system 110. Pages associated with different objects are stored and maintained by the social networking system, allowing social networking system users to access information about different objects by accessing a page associated with an object. For example, a page associated with an event object includes comments from users about the event, images associated with the event, information describing the event or other information associated with the event. In some embodiments, information about an object is presented as different stories in a newsfeed on the page associated with the event.

Certain social networking system users may be authorized to promote an object to other users. For example, a user authorized to promote an object (a “promoting user”) selected content associated with the object for distribution to other social networking system users. Examples of promoting users include: a page administrator for the page associated with the object, a creator of the object or the page or another user capable of modifying the object or the page associated with the object. A promoting user may also provide parameters specifying how selected content is distributed to other social networking system users. For example, the promoting user may associate targeting criteria with selected content to present the selected content to specific groups of users or to present the selected content for a specified duration. Parameters specifying distribution of selected content may also specify a budget and/or a bid amount to identify compensation provided to the social networking system for presenting the selected content to its users, allowing the promoting user to increase the likelihood that other users receive, or access, the selected content.

In the example of FIG. 1, a promoting user 105 requests 115 a page maintained by the social networking system 110 and associated with an object. For example, the promoting user 105 requests 115 a page associated with an event. Responsive to receiving the request, the social networking system 110 determines 125 whether the promoting user 105 is authorized to promote the object. The social networking system 110 maintains user profiles for its users that include demographic, and other, information about the users. A user profile may include data specifying whether a user is authorized to promote an object. For example, the user profile includes an object identifier associated with objects the user is authorized to promote, includes an object identifier and a flag indicating whether the user is authorize to promote the object or other suitable data. In some embodiments, the social networking system 110 accesses a user profile associated with the promoting user 105 and uses data in the user profile to determine 125 whether the promoting user 105 is authorized to promote the object associated with the requested page.

Responsive to the promoting user 105 being authorized to promote the object, the social networking system 110 transmits 130 the page 140 associated with the object and includes promotion functionality in the transmitted page 140, which includes one or more stories 142A, 142B, 142C (also referred to individually and collectively using reference number 142) associated with the object. For example, stories 142A, 142B, 142C include comments from social networking system users about the object, pictures associated with the object, links to external websites associated with the object, descriptions of social networking system user interactions with the object or with the page 140 or any other suitable data.

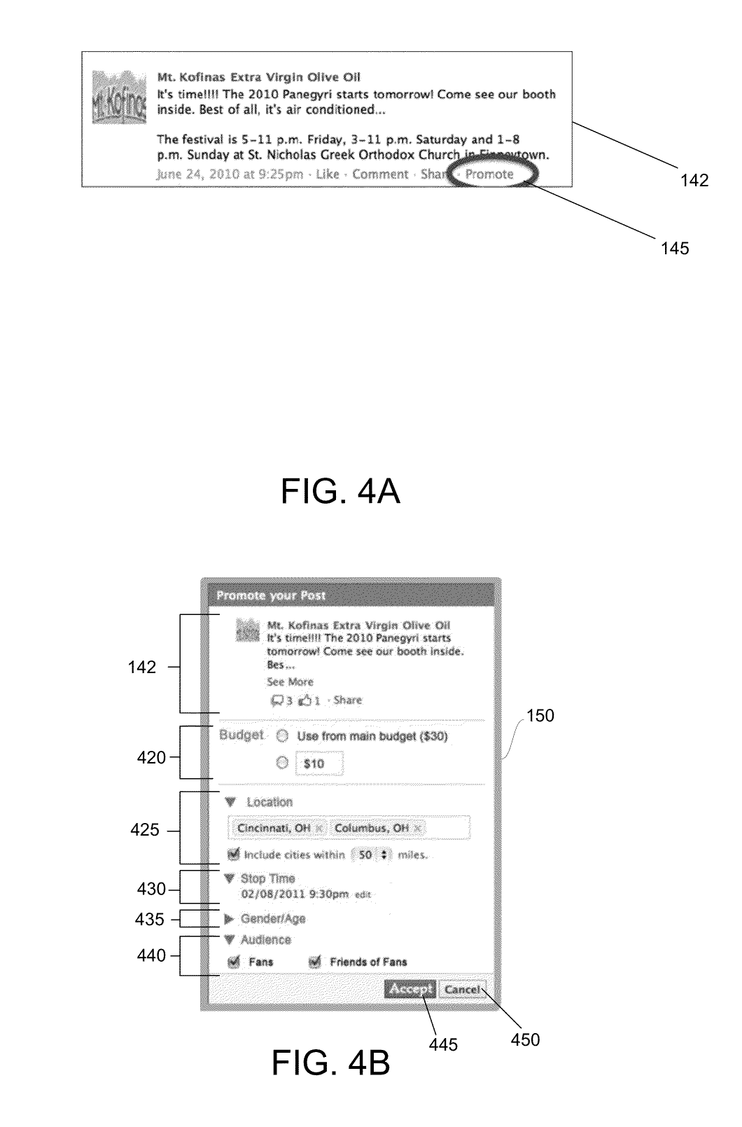

To allow the promoting user 105 to promote the object, the page 140 transmitted 130 to the promoting user 105 may include executable instructions that, when executed by a client device used by the promoting user 105, allow the page 140 to receive data from the promoting user 105 specifying a promotion of the object. The page 140 may be transmitted to other users that are not authorized to promote the object without the executable instructions described above. In the example of FIG. 1, the page 140 displays a promote option 145 associated with one or more of the displayed stories 142A, 142B, 142C proximate to the displayed stories 142A, 142B, 142C. While FIG. 1 shows a promote option 145 displayed proximate to each of the displayed stories 142A, 142B, 142C, in other embodiments the promote option 145 is displayed proximate to a subset of the displayed stories 142A, 142B, 142C. The promote option 145 may comprise a button, a link, an image or any other suitable user-accessible data. FIG. 4A, discussed in more detail below, illustrates an example story 142 having a promote option 145.

By accessing a promote option 145 associated with a displayed story 142A, 142B, 142C, the promoting user 105 is prompted for parameters used to promote the story 142 associated with the accessed promote option 145 to other social networking system users. In one embodiment, accessing the promote option 145 associated with a displayed story 142 presents a story promotion interface 150 to the promoting user 105. In FIG. 1, the promoting user 105 accesses the promote option 145 associated with the displayed story 142A, causing display of the story promotion interface 150 to allow the promoting user 105 to provide parameters for distributing the displayed story 142A to other social networking system users.

While FIG. 1 shows an embodiment where the promotion interface 150 is displayed in conjunction with the page 140, in other embodiments the promotion interface 150 may be displayed independently of the page 140 or may be displayed as a region within the page 140. For example, the promotion interface 150 may be a dialog box or a pop-up window displayed over a portion of the page 140. FIG. 4B, discussed in more detail below, illustrates an example promotion interface 150.

The promotion interface 150 identifies different parameters used by the social networking system 110 to distribute the story 142A to other users and allows the promoting user 105 to specify values for the different parameters. To simplify promotion of a story, or other content, the promotion interface 150 may display a subset of the parameters used by the social networking system 110 for story distribution, allowing the promoting user 105 to easily provide a smaller amount of parameters for modifying content distribution. Thus, rather than have the promoting user 105 provide a comprehensive set of parameters for distributing stories, the promotion interface 150 allows the promoting user 105 to provide a reduced amount of parameters for customizing content distribution. For purposes of illustration, the promotion interface 150 is described herein as receiving parameters used to promote a sponsored story; however, the promotion interface 150 may also receive parameters for promoting an advertisement, or other content, to social networking system users.

For example, the promotion interface 150 includes one or more fields 152A, 152B, 152C associated with types of parameters used by the social networking system 110 for content distribution. Examples of parameters associated with fields 152A, 152B, 152C in the promotion interface 150 include targeting criteria specifying one or more characteristics of users to receive the story associated with the accessed promote option, a budget for presenting the story associated with the accessed promote option to other users of the social networking system, a bid amount for compensating the social networking system 110 for presenting the story associated with the accessed promote button to other users a location associated with users to be presented the story associated with the accessed promote option, a time range for presenting the story associated with the accessed promote option to other users of the social networking system or other suitable parameters. FIGS. 4A and 4B provide further details about the page 140 and the promotion interface 150, respectively.

Parameters from the promoting user 105 received via the promotion interface 150 are transmitted to the social networking system 110, which subsequently uses the received parameters to generate a sponsored story request used to distribute an action and/or an object on which the story associated with the accessed promote button 150 is based. The sponsored story request allows the social networking system 110 to distribute the action or object to other users of the social networking system. For example, the sponsored story request is used by the social networking system 110 to generate a sponsored story that is distributed to a viewing user 120 that is connected to another user that performed the action specified by the generated sponsored story request. For purposes of illustration, FIG. 1 shows the social networking system 110 presenting 165 the story 142A associated with the accessed promote option 145 to a viewing user 120. If the promoting user 105 specifies targeting criteria via the promotion interface 150, the viewing user 120 is a social networking user having one or more of the characteristics specified by the targeting criteria.

In one embodiment, the viewing user 120 is presented 165 with the sponsored story produced by the sponsored story request corresponding to the story 142A associated with the accessed promote option 145 responsive to the viewing user 120 requesting content from the social networking system 110. For example, the viewing user 120 requests a newsfeed 170 including stories 172A, 172B describing actions by other users of the social networking system connected to the viewing user 120, and the story 142A associated with the accessed promote button 145 is also included in the newsfeed 170. The location of the story 142A in the newsfeed 170 may be based on an affinity of the viewing user 120 for a user, object or action included in the story 142A as well as compensation provided to the social networking system 110, specified by the promotion interface 150, for displaying the story 142, in addition to other factors. In other embodiments, the story 142A associated with the accessed promote button 145 may be presented responsive to a request for a page describing a user profile, a page describing a topic or entity in the social networking system 110 or other content maintained by the social networking system 110. While FIG. 1 shows presentation of the story 142A associated with the accessed promote button 145 in a newsfeed 170, the story 142A may be presented 165 via any suitable channel, such as via a notification, via a message or via a banner advertisement.

For example, a story 142 is a video of a movie trailer posted by the promoting user 105 or by a page administered by the promoting user 105. By accessing a promote option 145 associated with the story 142, the promoting user 105 may provide a bid amount, budget and/or targeting criteria used to generate a sponsored story request for the video via the promotion interface 150. When a user connected to the viewing user 120 interacts with the video, the social networking system 110 uses the sponsored story request generated by interaction with the promote button 145 and promotion interface 150 to generate a sponsored story presented to the viewing user 120 based on the action of the user connected to the viewing user 120. For example, if the user connected to the viewing user 120 commented on the video, the generated sponsored story may present “Friend A commented on the video. Click here to watch it yourself,” and may further identify the video by name or other descriptive information.

### System Architecture

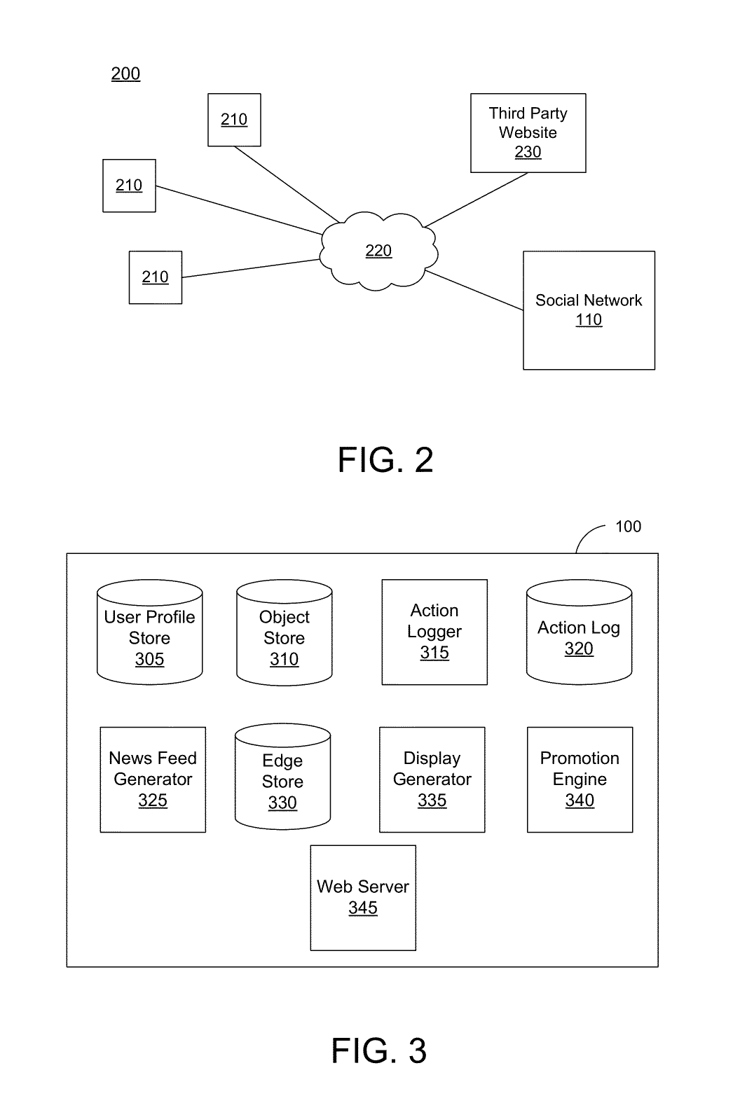

FIG. 2 is a high level block diagram illustrating a system environment 200 for a social networking system 110. The system environment 200 comprises one or more client devices 210, a network 220, one or more third-party websites 230 and the social networking system 110. In alternative configurations, different and/or additional components may be included in the system environment 200. The embodiments described herein can be adapted to online systems that are not social networking systems.

The client devices 210 comprise one or more computing devices capable of receiving user input as well as transmitting and/or receiving data via the network 220. In one embodiment, a client device 210 is a conventional computer system, such as a desktop or laptop computer. In another embodiment, a client device 210 may be a device having computer functionality, such as a personal digital assistant (PDA), mobile telephone, smart-phone or similar device. A client device 210 is configured to communicate via the network 220. In one embodiment, a client device 210 executes an application allowing a user of the client device 210 to interact with the social networking system 110. For example, a client device 210 executes a browser application to enable interaction between the client device 210 and the social networking system 110 via the network 220. In another embodiment, a client device 210 interacts with the social networking system 110 through an application programming interface (API) that runs on the native operating system of the client device 210, such as iOS® or ANDROID™.

The client devices 210 are configured to communicate via the network 220, which may comprise any combination of local area and/or wide area networks, using both wired and wireless communication systems. In one embodiment, the network 220 uses standard communications technologies and/or protocols. Thus, the network 220 may include links using technologies such as Ethernet, 802.11, worldwide interoperability for microwave access (WiMAX), 3G, 4G, CDMA, digital subscriber line (DSL), etc. Similarly, the networking protocols used on the network 220 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 220 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec). The third party website 230 may be coupled to the network 220 for communicating with the social networking system 110, which is further described below in conjunction with FIG. 3.

FIG. 3 is an example block diagram of a system architecture of the social networking system 110. The social networking system 110 includes a user profile store 305, an object store 310, an action logger 315, an action log 320, a newsfeed generator 325, and edge store 330, a display generator 335, a promotion engine 340 and a web server 345. In other embodiments, the social networking system 110 may include additional, fewer, or different modules for various applications. Conventional components such as network interfaces, security functions, load balancers, failover servers, management and network operations consoles, and the like are not shown so as to not obscure the details of the system architecture.

Each user of the social networking system 110 is associated with a user profile, which is stored in the user profile store 305. A user profile includes declarative information about the user that was explicitly shared by the user, and may also include profile information inferred by the social networking system 110. Hence, the user profile information stored in user profile store 305 describes the users of the social networking system 110, including biographic, demographic, and other types of descriptive information, such as work experience, educational history, gender, hobbies or preferences, location and the like. In one embodiment, a user profile includes multiple data fields, each field describing one or more attributes of the corresponding user of the social networking system 110. A user profile may also store other information provided by the user, for example, images or videos. In certain embodiments, images of users may be tagged with identification information of users of the social networking system 110 displayed in an image. A user profile in the user profile store 305 may also maintain references to actions by the corresponding user performed on content items in the object store 310 and stored in the action log 320.

A user profile may also include data indicating whether a user is authorized to promote an object. For example, a user profile includes an object identifier or reference to the object store 310 identifying objects a user is authorized to promote or an object identifier associated with a flag or other indicator whose value indicates whether the user is authorized to promote. A user authorized to promote an object may identify content associated with the object for presentation to other social networking system users and may also specify parameters to regulate how content associated with the object is presented to the other social networking system users. Including promotion authorization data in a user's profile allows the social networking system 110 may quickly determine the amount of functionality to provide to a user accessing a page associated with an object. This allows the social networking system 110 to limit or prevent unauthorized users from distributing content associated with an object while allowing authorized users to promote the object through content distribution.

The social networking system 110 maintains data describing a variety of different types of objects with which a social networking system user may interact. Examples of objects include events, plans, pictures, audio data, video data, groups or any other data maintained by the social networking system 110. The object store 310 includes data identifying each object maintained by the social networking system 110. For example, the object store 310 includes information fields associated with different types of objects, where data in the information fields describe attributes of characteristics of an object. For example, for event objects, the object store 310 includes fields specifying the time of the event, the location for an event, a listing of user invited to the event, images associated with the event and/or other suitable data. When a new object of a particular type is created, the social networking system 110 may initialize a data structure including fields associated with the corresponding object type, assigns a unique object identifier to the object and adds data to the fields. For example, if a user defines a new event the social networking system 110 generates a new instance of an event in the object store 310, assigns a unique identifier to the event, and populates the fields of the event with information describing the event.

Examples of information included in or associated with objects include major life events such as graduation, marriage or the birth of a child, as well as other events such as changes in user location, check-ins, comments on other items in the social networking system, tags to photos and other day to day occurrences. Objects may also include information not directly related to particular users. For example, an object may describe Paris, France and may have a picture of the Eiffel Tower uploaded by a user or may describe a product or service offered by a business or other entity. However, these are a few examples of the information comprising the objects of a social networking system 110, and many others are possible.

Objects may also be associated with metadata, which is included in the object store 310, in order to ease of use of the objects by the social networking system 110. Metadata may be included as tags in objects to link objects together based on similarity of content. Multiple objects may share metadata with each other, allowing a viewing user to easily transition between related objects using the metadata.

The action logger 315 receives communications about user actions on and/or off the social networking system 110, populating the action log 320 with information about user actions. Examples of user actions include adding a connection to another user, sending a message to another user, uploading an image, reading a message from another user, viewing content associated with another user, attending an event posted by another user, among others. In addition, a number of actions described in connection with objects are directed at particular users, so these actions are associated with those users as well. These actions are stored in the action log 320.

The action log 320 may be used by the social networking system 110 to track user actions on the social networking system 110, as well as external websites that communicate information to the social networking system 110. Users may interact with various objects on the social networking system 110, including commenting on posts, sharing links, and checking-in to physical locations via a mobile device, accessing content items in a sequence or other interactions. Information describing these actions is stored in the action log 320. Additional examples of interactions with objects on the social networking system 110 included in the action log 320 include commenting on a photo album, communications between users, becoming a fan of a musician, adding an event to a calendar, joining a groups, becoming a fan of a brand page, creating an event, authorizing an application, using an application and engaging in a transaction. Additionally, the action log 320 records a user's interactions with advertisements on the social networking system 110 as well as other applications operating on the social networking system 110. In some embodiments, data from the action log 320 is used to infer interests or preferences of the user, augmenting the interests included in the user profile and allowing a more complete understanding of user preferences.

The action log 320 may also store user actions taken on external websites, such as third-party website 230. For example, an e-commerce website that primarily sells sporting equipment at bargain prices may recognize a user of a social networking system 110 through social plug-ins that enable the e-commerce website to identify the user of the social networking system 110. Because users of the social networking system 110 are uniquely identifiable, e-commerce websites, such as this sporting equipment retailer, may use the information about these users as they visit their websites. The action log 320 records data about these users, including webpage viewing histories, advertisements that were engaged, purchases made, and other patterns from shopping and buying.

A newsfeed generator 325 selectively provides content to users of a social networking system 110 and records the consumption of content by users. In one embodiment, the newsfeed manager 325 generates stories for a user describing actions taken by other users of the social networking system 110 to whom the user is connected. For example, the newsfeed generated by the newsfeed manager 325 for a viewing user includes comments made by other users to whom the viewing user is connected. In another example, the newsfeed generated includes content posted to the social network system 110 by other users of the social networking system to whom the viewing user is connected or other actions taken by other users to whom the viewing user is connected. New newsfeed stories generated for a user by the newsfeed manager may be ranked and stored by the social networking system 110. The newsfeed manager 325 may communicate with client devices 210 through the network 220 to provide content to users of the social networking system 110.

When generating a newsfeed, the newsfeed generator 325 may select or rank stories based on a variety of data. For example, data provided by a user authorized to promote an object identifies characteristics of users to view a particular story or specifies a time interval during which a story is to be presented. The newsfeed generator 325 may compare this presentation data to characteristics of the user for whom a newsfeed is generated or to other information to determine whether to include a story in the newsfeed. Additionally, the newsfeed generator may account for bid amounts or budgets associated with a story by a promoting user and modify the likelihood of a story being included in a newsfeed based on the bid amounts and/or budget. Hence, the newsfeed generator 325 may allow a promoting user, or an advertiser, to increase the likelihood that a story is included in a newsfeed by compensating the social networking system 110 for including the story in a newsfeed (i.e., allowing the user to “sponsor” the story). Hence, users authorized to promote an object may provide the social networking system 110 with data customizing how interactions with the object are presented to different users.

In one embodiment, an edge store 330 stores the information describing connections between users and other objects on the social networking system 110 in edge objects. Some edges may be defined by users, allowing users to specify their relationships with other users or objects. For example, users may generate edges with other users that parallel the users' real-life relationships, such as friends, co-workers, partners, and so forth. Other edges are generated when users interact with objects in the social networking system 110, such as expressing interest in a page on the social networking system 110, sharing a link with other users of the social networking system 110, and commenting on posts made by other users of the social networking system 110. The edge store 330 stores edge objects that include information about the edge, such as affinity scores for objects, interests, and other users. Affinity scores may be computed by the social networking system 110 over time to approximate a user's affinity for an object, interest, and/or other users in the social networking system 110 based on the actions performed by the user. Multiple interactions between a user and a specific object may be stored in one edge object in the edge store 330, in one embodiment. In some embodiments, connections between users may be stored in the user profile store 310, or the user profile store 310 may access the edge store 330 to determine connections between users.

Data stored in the user profile store 305, the object store 310, the action log 320 and the edge store 330 allows the social networking system 110 to generate a social graph that uses nodes to identify various information items and edges connecting nodes to identify relationships between different items of information (e.g., users and objects, users and users, objects and objects, etc,). An edge between two nodes in the social graph represents a particular kind of connection between the two nodes, which may result from an action that was performed by one of the nodes on the other node.

The display generator 335 retrieves and displays content customized to a user viewing the content (a “viewing user”). For example, responsive to a request from a viewing user, the display generator retrieves a newsfeed from the newsfeed generator 325 and/or objects from the object store 310 and displays the retrieved content to the viewing user. The display generator 335 may provide a webpage or some other suitable display format to present content to the user via a client device 210. Additionally, the display generator 335 may generate a promotion interface 150 for receiving data used to modify distribution of content associated with an object from a user authorized to promote the object. In one embodiment, the display generator 335 also provides a promote option 145, as shown above in conjunction with FIG. 1, to a user authorized to promote an object when the user views data associated with the object. For example, the display generator 335 displays a button proximate to content associated with an object when a user authorized to promote the object views the content; this allows the user to interact with the button to promote the content to other users. Examples of content displayed by the display generator 335 are further described below in conjunction with FIGS. 4A and 4B.

The promotion engine 340 stores data for customizing distribution of content associated with the object. Data stored by the promotion engine 340 may be received via the promotion interface 150 provided by the display generator 335. For example, the promotion engine 340 accesses the user profile store 305 to identify users having one or more characteristics identified by targeting criteria stored in the promotion engine 340. As another example, the promotion engine 340 may also access stored budget information or bid amounts associated with stories, or other content, and provide the newsfeed generator 325 with the bid amounts and/or budgets for use in generating a ranked list of stories based on budget and/or bid amount.

In some embodiments, the promotion engine 340 may communicate content associated with an object being promoted to client devices 210 of viewing users. For example, if the content is a sponsored story or other advertisement the promote engine 340 may serve the sponsored story based on data associated with it, such as targeting criteria, bid amount or similar data. Hence, the data provided by a user authorized to promote an object via the promotion interface 150 is stored and applied by the promotion engine 340 to modify presentation of content to viewing users.

The web server 345 links the social networking system 110 via the network 220 to the one or more client devices 210, as well as to the one or more third party websites 230. The web server 345 serves web pages, as well as other web-related content, such as Java, Flash, XML and so forth. The web server 340 may provide the functionality of receiving and routing messages between the social networking system 110 and the client device 210, for example, instant messages, queued messages (e.g., email), text and SMS (short message service) messages, or messages sent using any other suitable messaging technique. A user may send a request to the web server 345 to upload data used to distribute content associated with an object from the client device 210 to the social networking system 110. Additionally, the web server 345 may provide API functionality to send data directly to native client device operating systems, such as iOS®, ANDROID™, webOS® or RIM.

### User Interface

FIG. 4A shows an example of a story 142 included on the page 140. As shown in FIG. 4A, the story 142 includes content associated with an object. In this example, the story 142 describes an event, although a story may include data about any type of object. For purposes of illustration, FIG. 4A shows a promote option 145, which is associated with the story, that is displayed proximate to the story 142 and associated with the story 142. As described above, the promote option 145 is displayed when the user viewing the page 140 is authorized to promote an object associated with the page 140, while the promote option 145 is not displayed if the user viewing the page 140 not authorized to promote the object associated with the page 140. In another embodiment, the promote option 145 is displayed to the user authoring or generating the story 142, but not to users that did not author or generate the story 142. Display of the promote option 145 may be further limited to social networking system entities that are a page or a brand or to social networking system users administering or creating the page or brand. While FIG. 4A shows the promote option 145 as the word “promote,” the promote option 145 may have any suitable appearance, such as an image, an icon or any other component capable of receiving input from the user.

Responsive to a user authorized to promote the object associated with the page 140 accessing the promotion option 145, a promotion interface 150, as shown in FIG. 4B, is presented to the user. The promotion interface 150 may be generated by the display generator 335 responsive to receiving an input that the promotion option 145 was accessed or may be generated by the client device 210 from which the page 140 is viewed executing instructions included in the page 140. The promotion interface 150 shown in FIG. 4B includes various fields associated with different data types, allowing a user to provide data by modifying the content of the fields. As described above, the promotion interface 150 is presented when a user authorized to promote an object associated with the page 140 accesses the promote option 145, but is not presented to users that are not authorized to promote the object.

In the example of FIG. 4B, the promotion interface 150 includes the story 142 associated with the accessed promote option 145, allowing the user to view the story 142 as it would be presented to other users and to readily identify the story 142 for which parameters being provided. The promotion interface 150 also includes fields for specifying parameters for distributing the story 142, such as targeting criteria and a budget. In one embodiment, the fields in the promotion interface 150 identify a subset of the parameters capable of being used to distribute the story, providing a user with a streamlined interface to expedite configuration of content distribution.

In the example of FIG. 4B the promotion interface 150 includes a budget field 420 allowing a user to specify a monetary amount used to compensate the social networking system 110 for distribution of the story 142. The user may provide compensation to the social networking system 110 to increase the likelihood that the story 142 is presented to the user, and the budget field 420 allows the user to specify a maximum amount for compensating the social networking system 110. The promotion interface 150 shown in FIG. 4B also includes one or more targeting fields for allowing a user to specify one or more targeting criteria identifying characteristics of users to be presented the story 142.

In FIG. 4B, various examples of targeting fields are shown, allowing a user to specify different targeting criteria. For example, a location field 425 allows a user promoting content to limit distribution of the story 142 to users with a location in their user profiles matching, or within a specified distance of, one or more locations identified by the location field 425. A duration field 430 allows a user to specify a time interval during which the story 142 is distributed to other users to limit promotion of the story. A gender/age field 435 allows a user to limit promotion of the story 142 to users having an age and/or gender in their user profiles matching data in the gender/age field 435. In one embodiment, the gender/age field 435 includes text boxes for receiving an age, age range and/or gender used to identify users to be presented the story 142. An audience field 440 receives data identifying additional criteria for identifying users to receive the story 142, such as whether users are fans of the page 140 or are friends with another user who is a fan of the page 140. An accept interface 445 receives an input confirming parameters entered into the promotion interface 150 while a cancel interface 450 receives an input discarding the parameters entered into the promotion interface and canceling promotion of the story 142 to other users.

### Method for Customizing Content Distribution

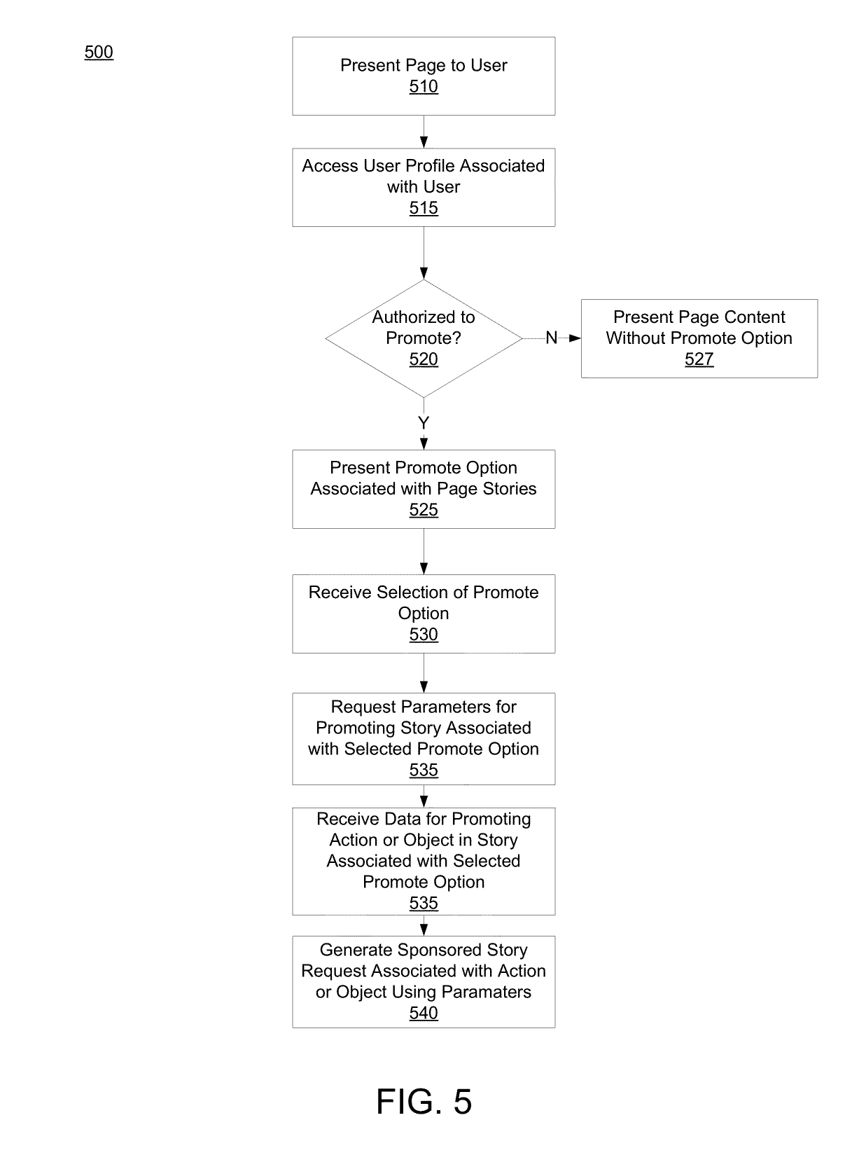

FIG. 5 illustrates one embodiment of a method 500 for promoting content in a social networking system 110. A page associated with an object maintained by the social networking system 110 is presented 510 to a user via a client device 210. For example, the user requests a page associated with an event, with a product or with a brand and a display generator 335 of the social networking system 110 generates the page for presentation to the user. The page includes one or more stories describing content associated with the event. Examples of content in the stories include comments by users, images, interactions between users and the object or the page. The social networking system 110 accesses 515 a user profile associated with the user, and stored in the user profile store 305, to determine 520 whether the user is authorized to promote the object associated with the page. As described above, certain social networking system users are authorized to distribute information about the object to other social networking system users. Examples of users authorized to promote the object include a user creating the object, a user creating a page associated with the object, a user maintaining the page or a user updating the object.

In one embodiment, a user profile includes data indicating whether a corresponding user is authorized to promote the object associated with the presented page. For example, a field in the user profile includes an object identifier and a field indicating whether the user is authorized to promote the identified object. Responsive to determining 520 the user is not authorized to promote the object, the page is presented 527 to the user without options to promote content included on the page. For example, the display generator 335 omits instructions for presenting an interface for promoting content when generating the page.

However, responsive to determining 520 the user is authorized to promote the object, a promote option is presented 525 to the user along with the page. In one embodiment, a promote option is associated with various stories included on the page and the promote option is displayed proximate to content included on the page and associated with the story, or other content, proximate to which it is displayed. For example, a promote option is presented 525 proximate to different stories, or other content, displayed on the page. Selecting a promote option allows the user to distribute the story, or other content, associated with the selected promote option (i.e., the story or content displayed proximate to the accessed promote option) to other social networking system users. FIGS. 1 and 4A show examples of a promote option being presented 525 in addition to content of a page.

In other embodiments, the promote option may receive data identifying a specific object to promote, such as an object identifier. Additionally, the promotion engine may infer an association between a promote option and an object based on context of the page in which the promote option is presented. For example, the promotion engine may access a uniform resource locator, or other page identifier, associated with the page on which a promote option is displayed to determine the object with which it is associated; the promotion engine may also access data describing objects presented on the page including the promote option and infer an association between the promote option and an object based on the description of objects presented on the page.

When the social networking system 110 receives 530 a selection of a promote option, parameters used to promote the story, or other content, associated with the selected promote option is requested 535 from the user. For example, a promotion interface is presented to the user, allowing the user to specify parameters used for distribution of the selected story to other users. An example promotion interface is described above in conjunction with FIG. 4B. In one embodiment, a subset of parameters capable of being used to distribute the story is requested 535, allowing the user to more easily provide parameters for targeting distribution of the story. For example, the promotion interface includes fields requesting 535 parameters commonly used to customize story distribution, such as those described above in conjunction with FIG. 4B. However, in other embodiments, the promotion information may request 535 an increased, or a further reduced, number of parameters.

Upon receiving 535 the parameters for story, or other content, promotion, the social networking system 110 generates 540 a sponsored story request associated with the action and/or the object included in the story associated with the selected promote option using the received parameters. For example, the received parameters specify a budget, a bid amount and targeting criteria for promoting the action or object included in the story to other users, and the social networking system 110 generates a sponsored story request including the received parameters and defining a condition for providing a sponsored story to a viewing user that describes an interaction with the action or the object in the sponsored story request. For example, the sponsored story request describes a condition for providing a sponsored story describing an action by a user connected to a viewing user with the action or the object identified by the sponsored story request.

The generated sponsored story request is stored by the social networking system 110 and used to present a sponsored story to viewing users having one or more characteristics identified by received targeting criteria. A sponsored story corresponding to the sponsored story request may be presented in a newsfeed for other users based on a received bid amount or budget specified by the parameters. Hence, by associating a promote option with content on a page associated with an object and displaying the promote option to users authorized to promote the object, the social networking system 110 simplifies customization of content distribution to other users.

In one embodiment, after the sponsored story request is generated and the corresponding sponsored story is presented to viewing users, a user authorized to promote the object may subsequently be presented with the page including the object, which presents the promote option proximate to the object for which the sponsored story was generated. By selecting the promote object associated with the object for which the sponsored story was generated, the user authorized to promote the object may be presented results of the promotion of the sponsored story. For example, the promotion interface is modified to display data describing promotion of the sponsored story associated with the object to other users after the sponsored story request has been generated or after the sponsored story has been presented to social networking system users. In one embodiment, the appearance of the promote option may be modified after the sponsored story request is generated to indicate that accessing the promote object presents data describing promotion of the sponsored story.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
presenting a page from a social networking system to a user, the page including a story associated with at least one of an action and an object in the social networking system;
displaying a promote option associated with the story;
responsive to receiving an input accessing the promote option, prompting the user to provide one or more parameters for defining a sponsored story request associated with at least one of the action and the object in the story associated with the accessed promote option, a parameter comprising a bid amount;
receiving the parameters from the user for defining the sponsored story request; and
storing the sponsored story request in a database, the sponsored story request defining a condition for providing a sponsored story to a viewing user who has a connection in the social networking system to another user who has interacted with at least one of the action and the object, the sponsored story describing the other user's interaction with at least one of the action and the object.

2. The method of claim 1, wherein the one or more parameters include a budget for presenting the sponsored story associated at least one or the action and the object in the story associated with the accessed promote option.

3. The method of claim 1, wherein displaying the promote option associated with the story comprises:
accessing a user profile associated with the user by the social networking system, the user profile including information indicating whether the user is authorized to promote the action or the object; and
responsive to determining the user is authorized to promote the action or the object, displaying the promote option.

4. The method of claim 1, further comprising:
sending the sponsored story for display to the viewing user.

5. The method of claim 1, wherein prompting the user to provide one or more parameters for defining a sponsored story request associated with at least one of the action and the object in the story associated with the accessed promote option comprises:
presenting one or more fields to the user, each field associated with a type of data for determining presentation of the sponsored story to other users of the social networking system.

6. The method of claim 5, wherein the one or more fields presented to the user are displayed along with the page.

7. The method of claim 5, wherein fields are associated with one or more of: a budget for presenting the sponsored story to other users of the social networking system, a location associated with users to be presented the sponsored story, a duration for presenting the sponsored story to other users of the social networking system and one or more characteristics of other users of the social networking system to be presented the sponsored story.

8. The method of claim 1, wherein presenting the page from a social networking system to a user comprises:
presenting a page including a news feed having a plurality of stories, the story associated with at least one of the action and the object included in the news feed.

9. A method comprising:
presenting a page from a social networking system associated with an object in the social networking system to a user, the page including stories associated with the object, each story associated with an action;
associating a promote option with each of the stories;
displaying the page so a promote option is displayed proximate to its associated story;
responsive to receiving an input accessing a promote option associated with a story, prompting the user to provide one or more parameters for defining a sponsored story request associated with an action in the story associated with the accessed promote option, a parameter including a bid amount;
receiving the parameters from the user for defining the sponsored story request; and
storing the sponsored story request in a database, the sponsored story request defining a condition for providing a sponsored story to a viewing user who has a connection in the social networking system to another user who has interacted with at least one of the action and the object, the sponsored story describing the other user's interaction with at least one of the action and the object.

10. The method of claim 9, wherein the one or more parameters include a budget for presenting the sponsored story to users of the social networking system.

11. The method of claim 9, wherein displaying the page so the promote option is displayed proximate to its associated story comprises:
accessing a user profile associated with the user by the social networking system, the user profile including information indicating whether the user is authorized to promote the object; and
responsive to determining the user is authorized to promote the object, displaying the promote option proximate to its associated story.

12. The method of claim 9, wherein displaying the page so the promote option is displayed proximate to its associated story comprises:
accessing a user profile associated with the user by the social networking system, the user profile including information indicating identifying stories generated by the user; and
displaying the promote option proximate to stories generated by the user.

13. The method of claim 9, further comprising:
sending the sponsored story for display to the viewing user.

14. The method of claim 9, wherein prompting the user to provide one or more parameters for defining the sponsored story request associated with an action in the story associated with the accessed promote option, comprises:
presenting one or more fields to the user, each field associated with a type of data for determining presentation of the sponsored story to other users of the social networking system.

15. The method of claim 14, wherein the one or more fields presented to the user are displayed along with the page.

16. The method of claim 14, wherein fields are associated with one or more of: a budget for presenting the sponsored story to other users of the social networking system, a location associated with users to be presented the sponsored story, a duration for presenting the sponsored story to other users of the social networking system and one or more characteristics of other users of the social networking system to be presented the sponsored story.

17. The method of claim 9, wherein displaying the page so the promote option is displayed proximate to its associated story comprises:
displaying textual data proximate to the story associated with the promote option.
